(19) United States
(12) Patent Application Publication
(10) Pub. No.: US 2013/0240448 A1
(43) Pub. Date: Sep. 19, 2013

(54) METHOD FOR SEPARATING WATER BY SEPARATION MEMBRANE, SEPARATION MEMBRANE FOR DEHYDRATING AQUEOUS ORGANIC ACID SOLUTION AND METHOD FOR MANUFACTURING THE SAME

(71) Applicant: HITACHI ZOSEN CORPORATION, Osaka-shi (JP)

(72) Inventors: Kenichi Sawamura, Osaka-shi (JP); Masanobu Aizawa, Osaka-shi (JP); Kentaro Shinoya, Osaka-shi (JP); Yoshinobu Takaki, Osaka-shi (JP); Kazuhiro Yano, Osaka-shi (JP)

(73) Assignee: HITACHI ZOSEN CORPORATION, Osaka-shi (JP)

(21) Appl. No.: 13/782,076

(22) Filed: Mar. 1, 2013

(30) Foreign Application Priority Data
Mar. 14, 2012 (JP) 2012-056749

(51) Int. Cl. C02F 1/44

(52) U.S. Cl. CPC C02F 1/44
USPC 210/651; 427/180

(57) ABSTRACT

The method for separating water by a separation membrane is a method for separating water from an aqueous organic acid solution by the separation membrane, and the separation membrane consists of polycrystalline membrane of mordenite (the chemical composition of the frame: AlₙSi₄₀₋ₙO₉₆, 2≦n≦, further, a major component of exchangeable cations present in ion exchange sites of the mordenite is protons (H⁺). The separation membrane for dehydrating an aqueous organic acid solution exhibits unexpectedly remarkable water permeability and has excellent acid resistance, without damaging water separation selectivity. The method for separating water using this separation membrane enables, for example, realizing the process of dehydrating acetic acid by the separation membrane, and a great energy saving. There are provided the above-described separation membrane for dehydrating an aqueous organic acid solution, and the method for manufacturing it.

### BACKGROUND OF THE INVENTION

The present invention relates to a method for separating water from an aqueous solution of an organic acid, for example, acetic acid, by means of a separation membrane, the dehydrating separation membrane used in this method for dehydrating an aqueous organic acid solution and a manufacturing method thereof.

Organic acids including acetic acid is one class of materials highly demanded in the chemical industries and are used as materials of various chemical products. Many of chemical products made from acetic acid, for example, however, generate a large amount of wastewater consisting of an aqueous acetic acid solution as a by-product in synthesizing them. Thus, the treatment of wastewater containing an aqueous acetic acid is needed, or alternatively, separation of water and acetic acid is necessary for the recovery of acetic acid from wastewater.

At present, although water and acetic acid are usually separated by distillation, in the separation of mixtures with small volatility ratio such as water and acetic acid, for example, incorporating membrane separation after distillation is expected to greatly reduce energy required for the separation.

Recently, separation membranes using zeolite are being actively developed, which is expected to have higher heat resistance and acid resistance than organic polymers, because dehydration membranes to be used in the dehydration of organic acids are required to have excellent durability in addition to high water permeability and selectivity.

Zeolite is a generic term for crystalline aluminosilicates which have a homogeneous regular pore structure with a diameter of about 0.3-1 nm. About two hundred kinds of zeolites are confirmed to exist, which can be distinguished at least by the pore structure though other differences may exist, such as types LTA, FAU, mordenite (MOR), MFI.

Physical and chemical properties of zeolite vary depending on the ratio of Si to Al in the zeolite frame-work (referred to the Si/Al ratio hereafter) and the type of exchangeable cations present in the ion exchange sites. As the zeolite membrane is a polycrystalline membrane, permeation and separation performances of the zeolite membrane are strongly dependent on the membrane structure such as the thickness of the zeolite layer, the orientation of pores and the structure of grain boundaries in addition to physical and chemical properties of zeolite per se. Thus, the properties of the zeolite membrane may vary widely, and the membrane design corresponding to the object of separation is required.

In the industrial application of zeolite membranes, aqueous isopropyl alcohol or ethanol solution has been so far dehydrated by the membrane of type A zeolite utilizing the strong hydrophilicity of the zeolite called as type A (type LTA structure, zeolite of Si/Al=1).

Use of a type A zeolite membrane in the dehydration of an aqueous solution of organic acid such as acetic acid has a limitation, however, that type A zeolite is dissolved by an acid.

Although acid resistance of zeolite is improved with increasing Si/Al ratio in the zeolite work, if Si/A ratio is too high, the zeolite membrane becomes hydrophobic, resulting in having too low water permeability to be utilized as a membrane for dehydration. Therefore, zeolite species having an intermediate Si/Al ratio such as MOR and ZSM-5 attract attention as a candidate zeolite for, dehydrating an aqueous organic acid solution.

JP 2001-240411A gazette discloses a mordenite (MOR) type zeolite membrane which has predominantly a particular crystal orientation and is formed on a porous substrate. The crystal orientation of such a mordenite type zeolite membrane is not limited, but is along either a-axes, b-axes or c-axes. This gazette describes that the mordenite type zeolite membrane has a higher ratio of silica and better acid resistance than type A zeolite membranes and Y type zeolite membranes; accordingly they can be preferably applied to uses requiring acid resistance in the fields such as molecular sieves and a catalyst.

In addition, JP 2010-13600A gazette describes a highly acid resistant and hydrophilic ZSM-5 type zeolite membrane having highly selective water permeability, and the method for manufacturing it.

On the other hand, when a separation membrane is industrially applied to dehydration of, for example, an aqueous acetic acid solution, the membrane is required to have the performance of, in addition to acid resistance, water permeability higher than 2×10⁻⁷ [mol/ (m²·s·Pa) ] and a separation coefficient a higher than 200 against water/acetic acid mixed vapor. In the present circumstances, however, a separation membrane having all of such permeability, selectivity and acid resistance has not yet developed.

### SUMMARY OF THE INVENTION

The present invention provides a method for separating water by a separation membrane which has solved above-described problems. That is, the invention provides the method for separating water using a separation membrane having excellent water permeability, water separation selectivity, and acid resistance for dehydrating an aqueous organic acid solution. Further, the invention provides a separation membrane for dehydrating an aqueous organic acid solution to be used in the method for separating water by a separation membrane and a method for manufacturing it.

The present inventors have concentrated all their energies on the study regarding to above-described problems and found that when a material composing a separation membrane is mordenite (MOR) type zeolite and the main component of exchangeable cations present in the ion exchange sites are protons (H⁺), and further, the membrane has a particular shape, the membrane exhibits remarkable water permeability in the dehydration of an organic acid, and as a result they have attained the present invention.

In order to attain the above-described purpose, the method for separating water through the separation membrane of the present invention is a method for separating water from an aqueous organic acid solution through the separation membrane, wherein the separation membrane consists of a polycrystalline membrane of mordenite (the chemical composition of the frame: AlₙSi₄₀₋ₙO₉₆, 2≦n≦8), and further the main component of exchangeable cations present in the ion exchange sites of mordenite is protons (H⁺).

Herein, an organic acid is preferably acetic acid. Another feature of the present invention comprises a separation membrane for dehydrating an aqueous organic acid solution used in the method for separating water, consisting of a polycrystalline membrane of mordenite (the chemical composition of the frame: AlₙSi₄₀₋ₙO₉₆, 2≦n≦8), wherein the main component of exchangeable cations present in the ion exchange sites of mordenite is protons (W), and the polycrystalline membrane of mordenite is obstructed by the connection of pore paths parallel to the c-axes with pores oriented in the different direction, the pore paths parallel to the c-axes being formed by at least the largest pore of 12-membered rings among pores consisting of 4, 5, 6, 8, and 12-membered oxygen rings.

The method of the invention for manufacturing the separation membrane for dehydrating an aqueous organic acid solution features that after a suspension of the powder of mordenite species crystal is applied to the surface of porous support and dried, the porous support with mordenite species crystal powder on the surface is subjected to hydrothermal synthesis in a synthesis solution containing SiO₂ and Al₂O₃, thereby forming a mordenite polycrystalline membrane, followed by ion-exchanging the cation species present in the ion exchange sites with protons (H⁺) using an acidic solution.

In the method of the invention for manufacturing the separation membrane for dehydration, preferably, the porous support is comprised of at least one porous body selected from the group consisting of alumina, silica and zirconia.

In the method for manufacturing the separation membrane for dehydration, the synthesis solution in hydrothermal synthesis has preferably the molar composition (100≦SiO₂/Al₂O₃≦400).

In the method of the invention for manufacturing the separation membrane for dehydration, preferably, the synthesis solution in hydrothermal synthesis contains further Na₂O, and the synthesis solution has the molar composition (40≦H₂O/Na₂O≦120, 0.1≦Na₂O/SiO₂≦0.4, and 100≦SiO₂/Al₂O₃≦400).

In the method of the invention for manufacturing the separation membrane for dehydration, it is preferable that the reaction temperature in hydrothermal synthesis is 100-200° C., and the reaction time is 4-48 hours.

In the method of the invention for manufacturing the separation membrane for dehydration, an acidic solution used in ion exchanging treatment of exchanging cations with protons is preferably an acidic aqueous solution with pH 1-3 comprised of at least one of hydrochloric acid, nitric acid and acetic acid.

The above-described method for separating water of the invention enables, without damaging the selectivity of water separation, unexpectedly remarkable water permeability to be effectuated; further, the method is able to be applied to an aqueous organic solution to be treated having a high water content (for example, the range with a water content of higher than 25 wt %) and to maintain a very high permeation rate and separation coefficient, that is, the performance of the separation membrane having the zeolite layer.

An organic acid is preferably acetic acid, and thereby, the process of dehydrating acetic acid can be realized by membrane separation and great energy saving can be achieved.

The separation membrane for dehydrating an aqueous organic acid solution used in the method for separating water consists of a polycrystalline membrane of mordenite (the chemical composition of the frame: AlₙSi₄₀₋ₙO₉₆, 2≦n≦8). Further, the main component of exchangeable cations present in the ion exchange sites of mordenite is protons (H⁺). And the polycrystalline membrane of mordenite is obstructed by the connection of pore paths parallel to the c-axes with pores oriented in the different direction, the pore paths parallel to the c-axes being formed by at least the largest pore of 12-membered rings among pores consisting of 4, 5, 6, 8, and 12-membered oxygen rings. Thereby, the separation membrane of the invention for dehydrating an aqueous organic acid solution is excellent in water permeability, water separation selectivity and acid resistance.

By using the above-described method of the invention for manufacturing the separation membrane for dehydrating an aqueous organic acid solution, the separation membrane for dehydrating an aqueous organic acid solution having high water permeability, good water separation selectivity and excellent acid resistance can be manufactured.

In the method of the invention for manufacturing the separation membrane for dehydration, the porous support is preferably comprised of at least one porous body selected from the group consisting of alumina, silica and zirconia, thereby, thinning of the separation membrane is enabled while keeping the strength of elements of the separation function layer.

In the method of the invention for manufacturing the separation membrane for dehydration, the synthesis solution in hydrothermal synthesis has preferably a molar composition (100≦SiO₂/Al₂O₃≦400), thereby, the mordenite polycrystalline membrane can be formed in which pore paths parallel to the c-axes are obstructed by being connected with other pores oriented in the different direction, the pore paths parallel to the c-axes being formed by at least 12-membered oxygen rings that are the largest pore.

In the method of the invention for manufacturing the separation membrane for dehydration, as the synthesis solution in hydrothermal synthesis further contains Na₂O, and has a molar composition (40≦H₂O/Na₂O≦120, 0.1≦Na₂O/SiO₂≦0.4, 100≦SiO₂/Al₂O₃≦400), a highly pure mordenite type zeolite membrane can be formed.

In the method of the invention for manufacturing the separation membrane for dehydration, the reaction temperature in hydrothermal synthesis is preferably 100-200° C., and the reaction time is preferably 4-48 hours; this enables a dense mordenite membrane with little defects to be synthesized.

In the method of the invention for manufacturing the separation membrane for dehydration, an acidic solution used in ion-exchange treatment exchanging cations with protons is preferably an aqueous one with pH 1-3 comprised of at least one of hydrochloric acid, nitric acid, acetic acid; thereby cation species present in ion exchange sites of mordenite can be exchanged with protons, without damaging excessively the host mordenite polycrystalline membrane.

The present invention will be described further in details referring the appended drawings.

### BRIEF DESCRIPTION OF THE DRAWINGS

FIG. 1 shows an enlarged perspective view schematically illustrating the crystalline structure of mordenite composing the separation membrane for dehydrating an aqueous organic acid solution of the present invention. Above the figure and at the left side of the figure, the cross-sectional shape of pore paths in the direction of c-axes and b-axes of the mordenite crystal are shown respectively;

FIG. 2 shows the scanning electron micrographic image (SEM) of the mordenite polycrystalline membrane composing the separation membrane for dehydrating an aqueous organic acid solution of the invention. At the right side of the figure, an enlarged perspective view is added, schematically illustrating a part of the mordenite crystal structure of the polycrystalline membrane; and

FIG. 3 shows a graph comparing the water permeability for acetic acid dehydration test in Example 1 performed using the method for water separation by the separation membrane of the invention and that in Comparable Example 1.

### DETAILED DESCRIPTION OF THE PREFERRED EMBODIMENTS

The method for separating water using a separation membrane of the present invention is a method separating water from an aqueous organic acid solution by a separation membrane wherein the separation membrane consists of polycrystalline membrane of mordenite (the chemical composition of the frame: AlₙSi₄₀₋ₙO₉₆, 2≦n≦8), and a major component of exchangeable cations present in ion exchange sites of mordenite is protons (H⁺).

The method for separating water of the invention enables, without damaging the selectivity of water separation, an unexpectedly remarkable water permeability to be effectuated, and further, the method is able to be applied to an aqueous organic solution to be treated having a high water content (for example, the range of higher than 25 wt. % water content) and maintain a very high permeation rate and separation coefficient, that is, the performance of the separation membrane having a zeolite layer.

The organic acid is preferably acetic acid. The method for separating water using a separation membrane of the invention is able to realize the process of dehydrating acetic acid by membrane separation, enabling a great energy saving.

A separation membrane for dehydrating an aqueous organic acid solution used in the method for separating water consists of a polycrystalline membrane of mordenite (the chemical composition of the frame: AlₙSi₄₀₋ₙO₉₆, 2≦n≦8). Further, a main component of exchangeable cations present in the ion exchange sites of mordenite is protons (H⁺). And the mordenite polycrystalline membrane is obstructed by the connection of pore paths parallel to the c-axes with other pores oriented in the different direction, the pore paths parallel to the c-axes being formed by at least 12-membered rings, that is, the largest of among pores consisting of 4, 5, 6, 8, and 12-membered oxygen rings. Thereby, the separation membrane for dehydrating an aqueous organic acid solution of the invention is excellent in water permeability, water separation selectivity and acid resistance.

The structure of mordenite is clarified by Meier, features 5-membered ring of tetrahedron of SiO₂, AlO₄, having pores consisted of 4, 5, 6, 8, and 12-membered oxygen rings. Pore paths (Channel) formed by the largest pore of 12-membered rings are parallel to c-axes, having both ends open like a tunnel, the cross-section being assumed not to be cyclic but oval with a diameter of 0.65-0.70 nm, unlike void type zeolites such as type A zeolite and faujasite.

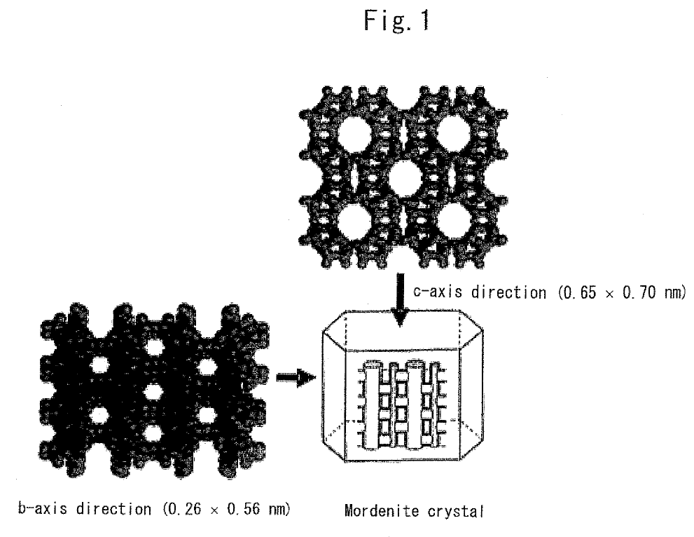

FIG. 1 shows an enlarged perspective view schematically illustrating the structure of mordenite composing the separation membrane for dehydrating an aqueous organic acid solution of the present invention. Above the figure and at the left side of the figure, the cross-sectional shapes of pore paths in the direction of c-axes and b-axes of mordenite crystal are shown respectively.

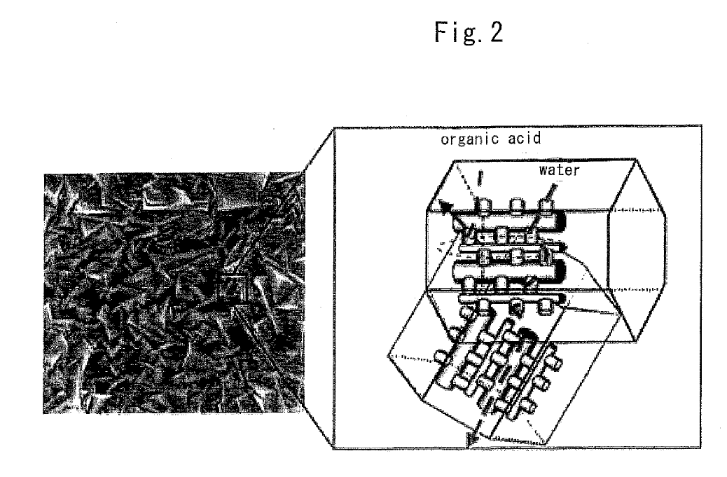

A separation membrane of the invention for dehydration of an aqueous organic acid solution features that the mordenite polycrystalline membrane is obstructed by the connection of pore paths parallel to the c-axes with pores oriented in the different direction, the pore paths parallel to the c-axes being formed by at least 12-membered rings, that is, the largest among pores consisting of 4, 5, 6, 8, and 12-membered oxygen rings. Generally, as the mordenite polycrystalline membrane has a larger pore diameter (0.65-0.70 nm) than the diameter of an acetic acid molecule (0.43 nm), acetic acid enters into pores of the mordenite polycrystalline membrane. In the present invention, however, the mordenite polycrystalline membrane is obstructed by the connection of pore paths parallel to the c-axes with other pores oriented in the different direction, the pore paths parallel to the c-axes being formed by at least 12-membered oxygen rings of the largest pore, while the other pore paths parallel to b-axes formed by 4, 5, 6, and 8-membered oxygen rings (refer to FIG. 2) are considered to be smaller than the molecular diameter (0.43 nm) of acetic acid, thereby, leading to the development of an unexpected remarkable effect suppressing the permeation of organic acid such as acetic acid.

FIG. 2 shows the SEM image of the mordenite polycrystalline membrane composing the separation membrane for dehydrating an aqueous organic acid solution of the invention. At the right side of the figure, there is added an enlarged perspective view schematically illustrating a part of the mordenite crystal structure of the polycrystalline membrane. As is apparent from FIG. 2, in the present invention, a part of the mordenite polycrystalline membrane composing the separation membrane for dehydrating an aqueous organic acid solution is obstructed by the connection of pore paths parallel to the c-axes with other pores oriented in the different direction, the pore paths parallel to the c-axes being formed by at least 12-membered rings, that is, the largest pore.

Then, the explanation will be given regarding the method for manufacturing the separation membrane for dehydrating an aqueous organic acid solution of the invention, that is, the method for manufacturing the mordenite polycrystalline membrane composing the separation membrane for dehydrating an aqueous organic acid solution.

The method for manufacturing a separation membrane for dehydrating an aqueous organic acid solution of the present invention features comprising steps of: applying a suspension of mordernite species crystal powder to a surface of a porous support and drying; then forming mordenite polycrystalline membrane by subjecting the porous support having mordenite species crystal powder on the surface to hydrothermal synthesis in a synthesis solution containing SiO₂ and Al₂O₃; then ion-exchanging cation species present in the ion exchange sites with protons (H⁺) using an acidic solution. Above-described cation species present in the ion exchange site include alkali metal cations such as Na⁺, K⁺, Li⁺, alkaline earth metal cations such as Ca²⁺, Sr²⁺, or organic cations such as NH₄⁺.

Generally, the zeolite membrane is formed first on the surface of a support in order to maintain it strongly and thin it. The supports include, for example, porous bodies such as alumina, silica, zirconia, but without limiting to them, various supports may be used. The shape of a support is usually plate-shaped, tubular, or hollow fibrous. In the case that the support is a porous body, its pore diameter is usually, 0.01-5 μm, preferably 0.05-2 μm.

The method for manufacturing a mordenite polycrystalline membrane comprises the steps of: applying a suspension of mordernite species crystal powder to the surface of a porous support and drying; then forming a mordenite polycrystalline membrane by subjecting the porous support having mordenite species crystal powder on the surface to hydrothermal synthesis in the synthesis solution containing SiO₂ and Al₂O₃, preferably Na₂O, SiO₂ and Al₂O₃.

The method for applying a suspension of mordernite species crystal powder to the surface of a porous support is, without limitation, preferably a rubbing or dipping method.

The above-mentioned rubbing method is a method wherein a suspension of mordenite species crystal powder is rubbed into the surface of a porous support, then dried followed by applying uniformly the zeolite powder (seed crystals) to the surface. On the other hand, the dipping method is a method comprising dipping a porous support in the suspension of mordenite species crystal powder to apply uniformly zeolite powder (seed crystals) to the surface.

A suspension of mordenite species crystal powder is applied to the surface of a porous support and dried, then subjected to hydrothermal synthesis; this hydrothermal synthesis can form the mordenite polycrystalline membrane from mordenite species crystal powder applied to the surface of the porous support.

The reaction temperature at hydrothermal synthesis is preferably 100-200° C., and the reaction time is, without limitation, preferably 4-48 hours. The temperature of 100-200° C. in hydrothermal synthesis is preferable because the mordenite polycrystalline membrane is uniformly formed on the surface of the porous support. The reaction time of 4-48 hours in hydrothermal synthesis is preferable because the membrane structure is formed in which mordenite crystals densely connect each other without void.

In the method of the invention for manufacturing a separation membrane for dehydrating an aqueous organic acid solution, the synthesis solution in hydrothermal synthesis has preferably a molar composition (100≦SiO₂/Al₂O₃≦400) in order to form a frame of mordenite polycrystalline membrane in which the ratio of Si and Al of mordenite crystals composing the membrane is 4≦Si/Al≦19. Thereby, the mordenite polycrystalline membrane can be formed in which the pore paths parallel to the c-axes are obstructed by the connection with other pores oriented in the different direction, the pore paths parallel to c-axes being formed by at least 12-membered oxygen rings, that is, the largest pore.

In the method of the invention for manufacturing a separation membrane for dehydration, it is preferable that the synthesis solution in hydrothermal synthesis contains further Na₂O, and has a molar composition (40≦H₂O/Na₂O≦120, 0.1≦Na₂O/SiO₂≦0.4, and 100≦SiO₂/Al₂O₃≦400). This has an advantage that a highly pure mordenite type zeolite membrane can be formed.

In the method of the invention for manufacturing a separation membrane for dehydration, the porous support is preferably comprised of at least one of porous bodies selected from the group consisting of alumina, silica and zirconia. This enables the separation function layer to be thinned while ensuring the separation membrane elements to be strong.

In the method of the invention for manufacturing a separation membrane for dehydration, the synthesis solution in hydrothermal synthesis has preferably a molar composition (100≦SiO₂/Al₂O₃≦400). Thereby, the mordenite polycrystalline membrane can be formed in which pore paths parallel to the c-axes are obstructed by being connected with pores oriented in the different direction, pore paths parallel to the c-axes being formed by at least 12-membered oxygen rings, that is, the largest pore.

In the method of the invention for manufacturing a separation membrane for dehydration, it is preferable that the synthesis solution in hydrothermal synthesis contains further Na₂O, and has a molar composition (40≦H₂O/Na₂O≦120, 0.1≦Na₂O/SiO₂≦0.4, and 100≦SiO₂/Al₂O₃≦400). This has an advantage that a highly pure mordenite type zeolite membrane can be formed.

In the method of the invention for manufacturing a separation membrane for dehydration, the reaction temperature in hydrothermal synthesis is preferably 100-200° C., and the reaction time is preferably 4-48 hours. This enables a dense mordenite membrane with little defects to be synthesized.

In the method of the invention for manufacturing a separation membrane for dehydration, an acidic solution used in the treatment of ion exchange with protons is preferably an aqueous acidic solution with pH 1-3 comprised of at least one of hydrochloric acid, nitric acid, acetic acid. Thereby cation species present in ion exchange sites of mordenite can be exchanged with protons, without damaging excessively the matrix mordenite polycrystalline membrane.

By using the method of the invention for manufacturing a separation membrane for dehydrating an aqueous organic acid solution, the separation membrane for dehydrating an aqueous organic acid solution can be manufactured which has high water permeability, excellent water separation selectivity and acid resistance.

In the followings, examples of the present invention will be described with comparative examples. However, those examples do not limit the present invention by any means.

### EXAMPLE 1

Mordenite polycrystals used in the separation membrane for dehydrating an aqueous organic acid solution of the present invention were synthesized on the surface of a porous alumina tube (the support pore diameter: 0.1-1 μm).

At first, a suspension of mordenite species crystal powder (trade name: Mordenite type Zeolite, made by TOSOH CORPORATION) was applied to the surface of a porous alumina tube by a dipping method. After dried 24 hours, the porous support with mordenite species crystal powder on the surface was subjected to hydrothermal synthesis in the synthesis solution having a molar composition ratio (H₂O/Na₂O=96, Na₂O/SiO₂=0.3, SiO₂/Al₂O₃=240), at a temperature of 180° C., for 6 hours to form a mordenite polycrystalline membrane. Next, the synthesized mordenite membrane was immersed in a 50 wt % aqueous acetic acid solution at 70° C. for 7 hours, to replace Na cations present in ion exchange sites in mordenite pores with protons.

FIG. 1 shows scanning electron microscopy (SEM) images of the obtained mordenite polycrystalline membrane composing the separation membrane for dehydrating an aqueous organic acid solution of the present invention. As apparent in this FIG. 1, in the separation membrane for dehydrating an aqueous organic acid solution of the invention, the mordenite polycrystalline membrane composing the separation membrane for dehydrating an aqueous organic acid solution is obstructed by the connection of pore paths parallel to the c-axes with pores oriented in the different direction, the pore paths parallel to the c-axes being formed by at least 12-membered rings, that is, the largest pore.

It was confirmed by X-ray diffraction (XRD) measurement that the crystals composing the zeolite membrane was mordenite. It was confirmed also by X-ray photoelectron spectroscopy (XPS) measurement that the mordenite composing the membrane had a Si/Al ratio of about 6-15. Further, it was confirmed by a transmission electron microscopy (TEM) measurement that mordenite crystals composing the membrane constructed the structure in which they were connected densely with each other without voids.

### COMPARATIVE EXAMPLE 1

For comparison, a mordenite membrane is synthesized on the surface of a porous alumina tube in the same way as above-described Example 1, with the exception that cation species present in ion exchange sites of the mordenite are Na cations because the inside of zeolite pores was not protonated with an acidic solution differently from above-described Example 1.

### COMPARATIVE EXAMPLES 2

For comparison, a mordenite membrane was synthesized on the surface of a porous alumina tube in the same way as above-described Example 1, with the exception that ZSM-5 type zeolite membrane was used differently from above-described Example 1.

First, a suspension of ZSM-5 type zeolite species crystal powder (trade name: ZSM-5 type Zeolite, made by TOSOH CORPORATION) was applied to the surface of a porous alumina tube by a dipping method. After dried for 24 hours, the porous support with ZSM-5 type zeolite type crystal powder on the surface was subjected to hydrothermal synthesis in the synthesis solution having a molar composition ratio (H₂O/Na₂O=96, Na₂O/SiO₂=0.3, SiO₂/Al₂O₃=240), at a temperature of 180° C. for 6 hours to form a ZSM-5 type zeolite polycrystalline membrane.

Then, the crystals composing zeolite membranes were confirmed to be ZSM-5 type zeolite by an X-ray diffraction (XRD) measurement. Also, it was confirmed by X-ray photoelectron spectroscopy (XPS) measurement, that the ZSM-5 type zeolite composing the membrane has a Si/Al ratio of about 12-20. Further, it was confirmed by a transmission electron microscopy (TEM) measurement that the ZSM-5 type zeolite crystals composing the membrane constructed the structure in which they were connected densely with each other without voids.

### COMPARATIVE EXAMPLE 3

For comparison, a zeolite membrane was synthesized on the surface of a porous alumina tube in the same way as above-described Example 1, with the exception that ZSM-5 type zeolite membrane was used, and cation species present in ion exchange sites of the ZSM-5 are Na cations, differently from above-described Example 1 because the inside of zeolite pores was not protonated with an acidic solution.

### ≦Acetic Acid Dehydration Test>

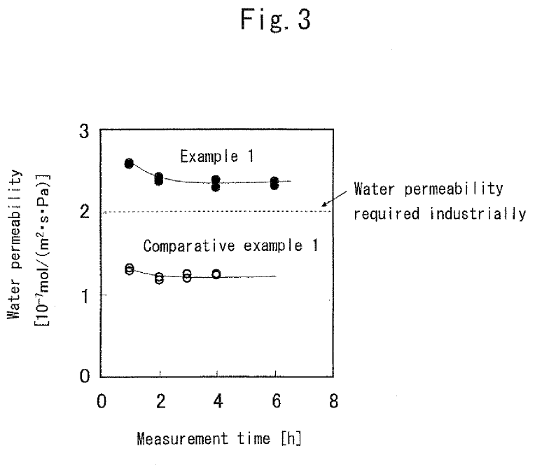

Next, in order to examine the ability of dehydrating acetic acid of the mordenite polycrystalline membrane and the zeolite membrane obtained in above-described Example 1 and Comparative Example 1, tests of dehydrating 50 weight % aqueous acetic acid solution were performed at a temperature of 130° C. under normal pressure. Respective membranes were fitted to a stainless steel module, 50 weight aqueous acetic acid solution was supplied in a vaporized state, and permeated amounts of water and acetic acid through the membranes were measured. From the measurement of permeated amounts through the membrane, membrane permeability [mol/ (m2·s·Pa) ] per unit time, unit area, and unit pressure were calculated. Obtained results are shown in a graph of FIG. 3.

As is apparent from the results in the graph of FIG. 3, the mordenite polycrystalline membrane composing the separation membrane for dehydrating an aqueous organic acid solution obtained in Example 1 of the present invention allows water to permeate with a permeability higher than 2×10⁻⁷ [mol/(m²·s·Pa)], while the permeation of acetic acid is below the detection limit, with high water/acetic acid separation selectivity α>1000 exhibited. On the contrary, the mordenite membrane obtained in Comparative Example 1 which did not undergo protonation of the inside of zeolite pores by an acidic solution, had about half water permeability compared with that of Example 1.

In addition, the effect of protonation by the acidic solution treatment was examined in Comparative Examples 2 and 3. As a result, in the case of ZSM-5 type zeolite membranes, ion exchange of Na cations in ion exchange sites with protons increased water permeability, though the water/acetic acid separation performances have been almost lost.

As is apparent from the facts, an acidic solution treatment alone in which cation species in the ion exchange sites are ion-exchanged with protons is not always efficient. In order to enhance the performance of water permeation and separation, a certain requisite must be satisfied as in the case of Example 1; for example, a zeolite membrane used as a matrix should be mordenite type, and the membrane should have a specific shape.

FIG. 1

1 c-axis direction (0.65×0.70 nm)

2 b-axis direction (0.26×0.56 nm)

3 Mordenite crystal

FIG. 2

4 organic acid

5 water

FIG. 3

1 Water permeability [10⁻⁷mol/ (m2·s·Pa)]

2 Example 1

3 Comparative example 1

4 Measurement time [h]

5 Water permeability required industrially

1. A method for separating water from an aqueous organic acid solution by a separation membrane, wherein the separation membrane consists of mordenite (the chemical composition of the frame: AlₙSi₄₀₋ₙO₉₆, 2≦n≦8) polycrystalline membrane and further, a major component of exchangeable cations present in ion exchange sites of the mordenite is protons (H⁺).

2. The method for separating water by the separation membrane according to claim 1 wherein the organic acid is acetic acid.

3. The separation membrane for dehydrating an aqueous organic acid solution used in the method for separating water according to claim 1, wherein the membrane consists of mordenite (the chemical composition of the frame AlₙSi₄₀₋ₙO₉₆, 2≦n≦8) polycrystalline membrane, and further wherein a major component of exchangeable cations present in ion exchange sites of the mordenite is protons (H⁺), and the mordenite polycrystalline membrane is obstructed by the connection of pore paths parallel to the c-axes with pores oriented in the different direction, the pore paths parallel to the c-axes being formed by at least 12-membered rings, that is, the largest pore among pores consisting of 4, 5, 6, 8, and 12-membered oxygen rings.

4. The method for manufacturing the separation membrane for dehydrating an aqueous organic acid solution according to claim 3, wherein the suspension of the mordenite species crystal powder is applied to the surface of a porous support and dried, then the porous support having the mordenite species crystal powder on the surface is subjected to hydrothermal synthesis in a synthesis solution containing SiO₂ and Al₂O₃ to form the mordenite polycrystalline membrane, after that, cation species present in the ion exchange sites are ion-exchanged with protons (H⁺) using an acidic solution.

5. A method for manufacturing the separation membrane for dehydrating an aqueous organic acid solution according to claim 4, wherein the porous support is comprised of at least one porous body selected from the group consisting of alumina, silica and zirconia.

6. The method for manufacturing the separation membrane for dehydrating an aqueous organic acid solution according to claim 4, wherein the synthesis solution in hydrothermal synthesis has a molar composition (100≦SiO₂/Al₂O₃≦400).

7. The method for manufacturing the separation membrane for dehydrating an aqueous organic acid solution according to claim 4, wherein the synthesis solution in hydrothermal synthesis contains further Na₂O, and has a molar composition (40≦H₂O/Na₂O≦120, 0.1≦Na₂O/SiO₂≦0.4, 100≦SiO₂/Al₂O₃≦400).

8. The method for manufacturing the separation membrane for dehydrating an aqueous organic acid solution according claim 4, wherein the reaction temperature in hydrothermal synthesis is 100-200° C. and the reaction time is 4-48 hours.

9. The method for manufacturing the separation membrane for dehydrating an aqueous organic acid solution according claim 4, wherein the acidic solution used in the treatment of ion exchange with protons is an acidic solution with pH 1-3 comprised of at least one of hydrochloric acid, nitric acid and acetic acid.

10. The method for manufacturing the separation membrane for dehydrating an aqueous organic acid solution according to claim 5, wherein the synthesis solution in hydrothermal synthesis has a molar composition (100≦SiO₂/Al₂O₃≦400).

11. The method for manufacturing the separation membrane for dehydrating an aqueous organic acid solution according to claim 5, wherein the synthesis solution in hydrothermal synthesis contains further Na₂O, and has a molar composition (40≦H₂O/Na₂O≦120, 0.1≦Na₂O/SiO₂≦0.4, 100≦SiO₂/Al₂O₃≦400).

12. The method for manufacturing the separation membrane for dehydrating an aqueous organic acid solution according claim 5, wherein the reaction temperature in hydrothermal synthesis is 100-200° C. and the reaction time is 4-48 hours.

13. The method for manufacturing the separation membrane for dehydrating an aqueous organic acid solution according claim 6, wherein the reaction temperature in hydrothermal synthesis is 100-200° C. and the reaction time is 4-48 hours.

14. The method for manufacturing the separation membrane for dehydrating an aqueous organic acid solution according claim 7, wherein the reaction temperature in hydrothermal synthesis is 100-200° C. and the reaction time is 4-48 hours.

15. The method for manufacturing the separation membrane for dehydrating an aqueous organic acid solution according claim 10, wherein the reaction temperature in hydrothermal synthesis is 100-200° C. and the reaction time is 4-48 hours.

16. The method for manufacturing the separation membrane for dehydrating an aqueous organic acid solution according claim 11, wherein the reaction temperature in hydrothermal synthesis is 100-200° C. and the reaction time is 4-48 hours.

17. The method for manufacturing the separation membrane for dehydrating an aqueous organic acid solution according claim 5, wherein the acidic solution used in the treatment of ion exchange with protons is an acidic solution with pH 1-3 comprised of at least one of hydrochloric acid, nitric acid and acetic acid.

18. The method for manufacturing the separation membrane for dehydrating an aqueous organic acid solution according claim 6, wherein the acidic solution used in the treatment of ion exchange with protons is an acidic solution with pH 1-3 comprised of at least one of hydrochloric acid, nitric acid and acetic acid.

19. The method for manufacturing the separation membrane for dehydrating an aqueous organic acid solution according claim 7, wherein the acidic solution used in the treatment of ion exchange with protons is an acidic solution with pH 1-3 comprised of at least one of hydrochloric acid, nitric acid and acetic acid.

20. The method for manufacturing the separation membrane for dehydrating an aqueous organic acid solution according claim 8, wherein the acidic solution used in the treatment of ion exchange with protons is an acidic solution with pH 1-3 comprised of at least one of hydrochloric acid, nitric acid and acetic acid.
